(19) United States
(12) Patent Application Publication
(10) Pub. No.: US 2014/0082531 A1
(43) Pub. Date: Mar. 20, 2014

(54) FILE READER AND FILE INFORMATION DISPLAYING METHOD

(71) Applicant: HON HAI PRECISION INDUSTRY CO., LTD., New Taipei (TW)

(72) Inventors: CHUNG-I LEE, New Taipei (TW); CHIEN-FA YEH, New Taipei (TW); I-CHIN HUNG, New Taipei (TW)

(73) Assignee: HON HAI PRECISION INDUSTRY CO., LTD., New Taipei (TW)

(21) Appl. No.: 13/967,242

(22) Filed: Aug. 14, 2013

(30) Foreign Application Priority Data
Sep. 18, 2012 (TW) 101134083

(51) Int. Cl. G06F 3/048

(52) U.S. Cl. CPC G06F 3/048
USPC 715/762

(57) ABSTRACT

A file reader identifies a drawing part, a text part of a file, and figures contained in the drawing part, figure labels, and component labels of the figures using optical character recognition. The file reader further identifies brief descriptions of the figures, the component labels, component names from the text part, and the figure labels from the brief descriptions. In addition, the file reader displays miniatures of the figures in a first area of a user interface, displays a figure corresponding to a selected miniature in a second area of the user interface, displays control buttons in a third area of the user interface, and displays the brief descriptions of the figures in a fourth area of the user interface.

### BACKGROUND

1. Technical Field

Embodiments of the present disclosure relate to data information displaying technology, and more particularly to a file reader and a method of displaying file information.

2. Description of Related Art

When reading an electronic document having related sections spread over many pages, a user must scroll back and forth when the user need to correlate different sections of a document, e.g., textual description with figures. A user could also open two instant of the same document and view them side by side if the display is large enough. Both methods are inconvenient, because one requires tedious scrolling back and forth and the other needs a large expensive display

### BRIEF DESCRIPTION OF THE DRAWINGS

FIG. 1 is a block diagram of one embodiment of function modules of a file reader.

FIG. 2 shows an example of a user interface provided by the file reader in FIG. 1.

FIG. 3A and FIG. 3B are a flowchart of one embodiment of a file information displaying method.

FIG. 4A and FIG. 4B illustrate rotation operations on a figure contained in a file.

FIG. 5 and FIG. 6 illustrate displaying information of a patent file in the user interface shown in FIG. 2.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

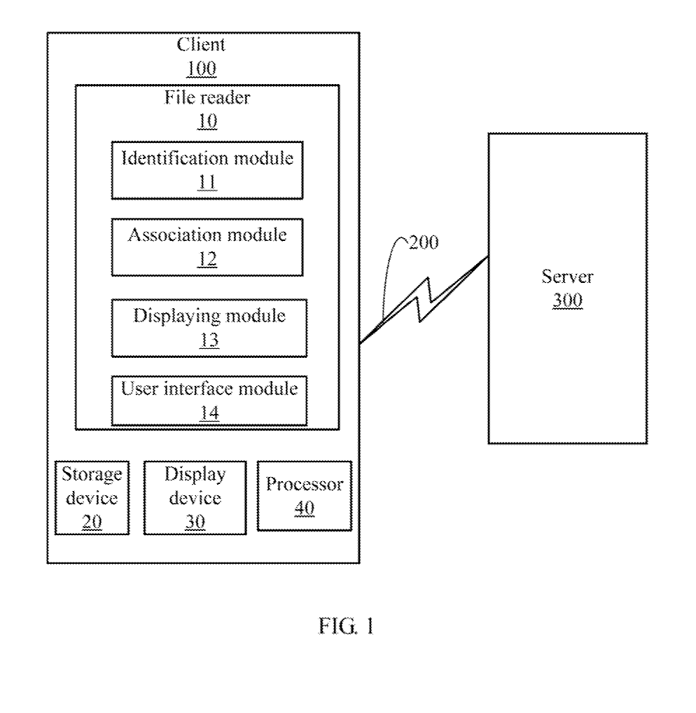

FIG. 1 is a block diagram of one embodiment of a client 100 that includes a file reader 10. In one embodiment, the client 100 can be connected to a server 300 via a network 200. In other embodiments, the file reader 10 may be installed in any server or other computing device.

The client 100 further includes a storage device 20, a display device 30, and a processor 40. The storage device 20 can be a dedicated memory, such as an EPROM, a hard disk driver (HDD), or flash memory. In one embodiment, the storage device 20 stores files created by the client 100 or downloaded from the server 300 via the network 200. For example, the files created or downloaded can be patent publications or patent applications.

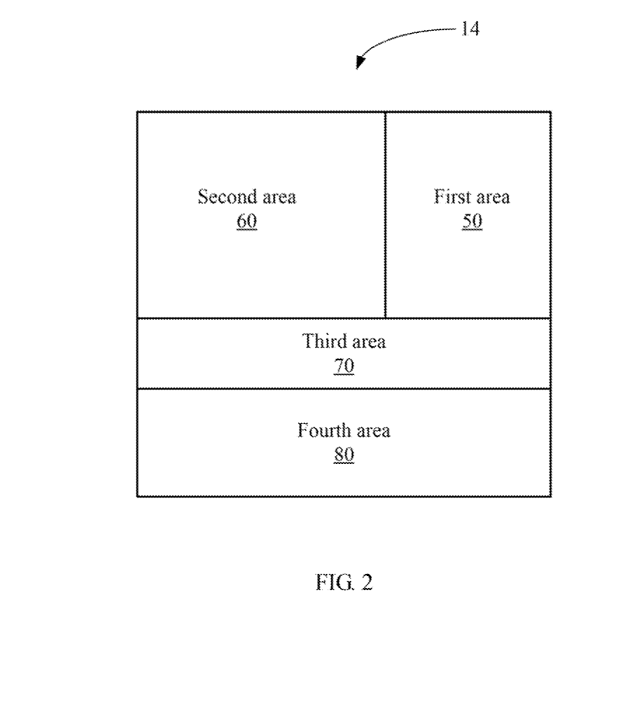

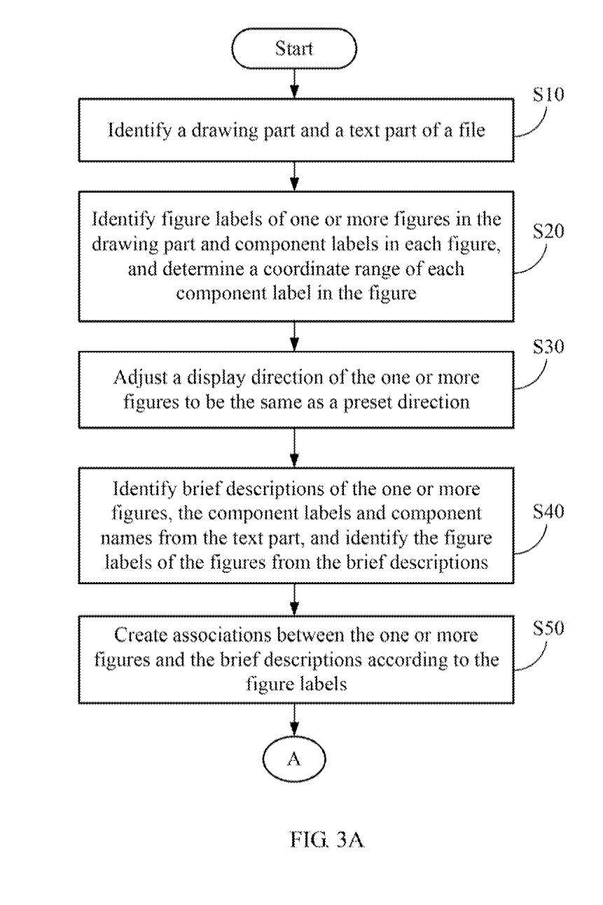

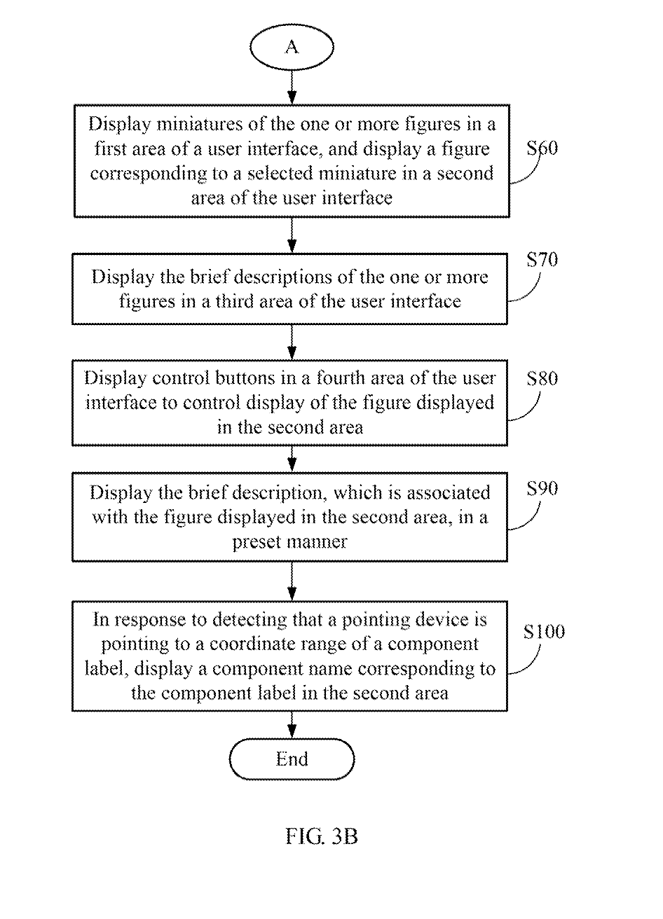

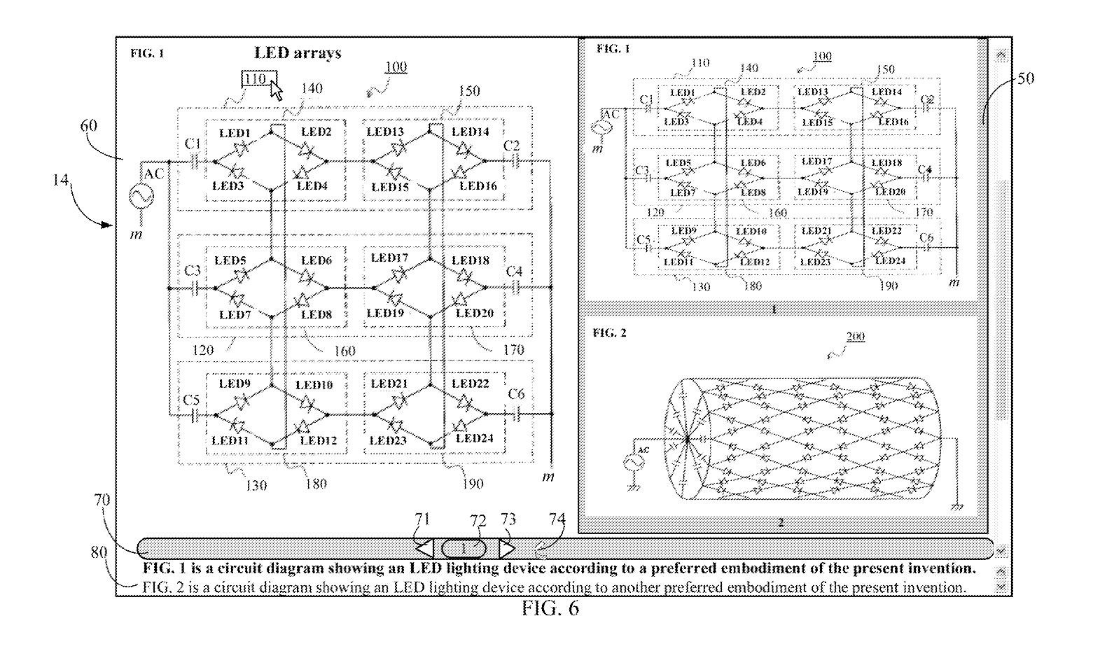

As shown in FIG. 1, the file reader 10 includes a plurality of function modules, such as an identification module 11, an association module 12, a displaying module 13, and a user interface module 14. Utilizing modules 11-14, the file reader 10 identifies a text part and a drawing part of a file selected by a user, displays the drawing part and the text part in different areas (refer to FIG. 2, FIG. 5, and FIG. 6) of the user interface module 14, to facilitate the user's reading of the file content. As shown in FIG. 2, the user interface module 14 includes a first area 50, a second area 60, a third area 70, and a fourth area 80. The modules 11-14 include computerized code in the form of one or more programs that are stored in the storage device 20. The computerized code includes instructions that are executed by the processor 40 to provide aforementioned functions of the file reader 10. Detailed functions of the modules 11-13 are given in reference to FIG. 3A and FIG. 3B.

FIG. 3A and FIG. 3B show a flowchart of one embodiment of a file information displaying method. Depending on the embodiment, additional steps may be added, others removed, and the ordering of the steps may be changed.

In step S10, the identification module 11 identifies a drawing part and a text part of a file. In one embodiment, the file is a patent file in a PDF format. The drawing part of the patent file in the PDF format may include one or more figures. Each figure is labeled by a figure label, such as “FIG. 1” or “FIG. 2,” at either bottom or top of the figure. The figure may consist of one or more components distinguished by different component labels, such as “100,” “200.” The text part of the patent file includes several parts, such as a “Technical Field” part, a “Brief Description of The Drawings” part, a “Detailed Description” part, and a “Claims” part.

In step S20, the identification module 11 identifies the figure labels of the one or more figures in the drawing part and the component labels in each figure, and determines a coordinate range of each component label. In this embodiment, an optical character recognition (OCR) technology may be used to identify the character information. The coordinate range is a region enclosing the component label. For example, as shown in FIG. 6, the coordinate range of the component label “110” can be a rectangle enclosing the component label “110.”

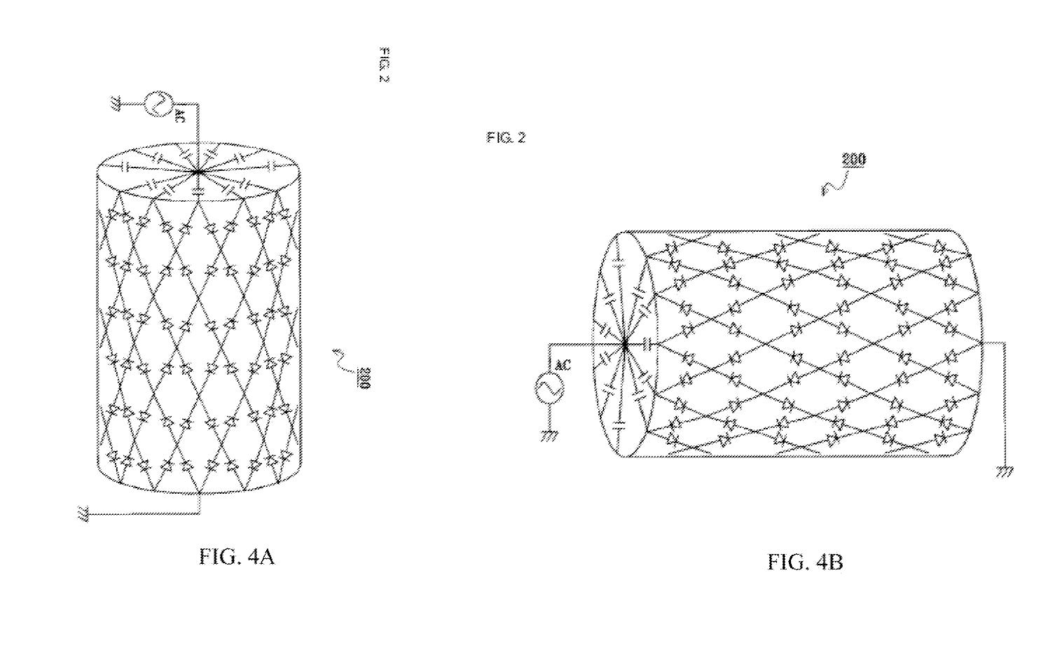

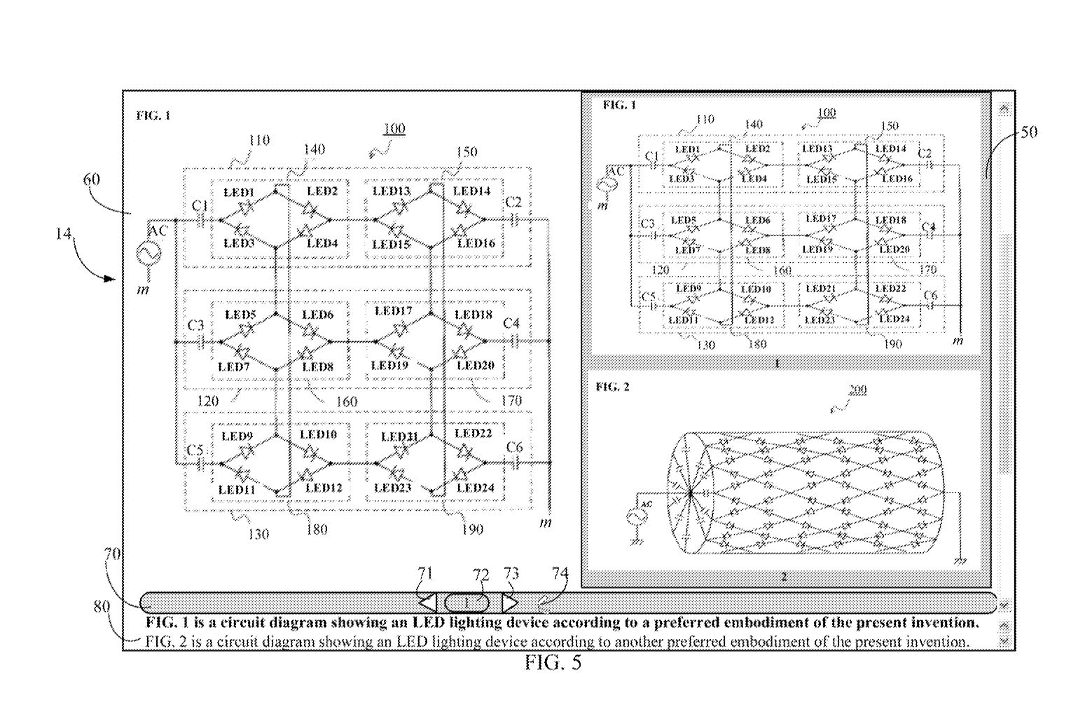

In step S30, the identification module 11 determines if a display direction of each figure in the drawing part is the same as a preset direction (such as a horizontal direction), and adjusts the display direction of the figure to be the same as a preset direction by rotating the figure. In one embodiment, if the display direction of the component label in the figure is not the same as the preset direction, the display direction of the figure is determined as different from the preset direction. For example, as shown in FIG. 4A, the figure label “FIG. 2” and the component label “200” are vertical, so the identification module 11 may rotate the figure counter-clockwise by substantially 90 degrees to obtain the figure shown in FIG. 4B. The drawing part including the adjusted figure can be stored in the storage device 20.

In step S40, the identification module 11 identifies brief descriptions of the figures, the component labels and component names from the text part. For example, the brief descriptions of the figures can be retrieved from the “Brief Description of The Drawings” part in the text part of the patent file. In one embodiment, the component labels and component names are identified from the text part using OCR technology in combination with grammar rules. For example, the identification module 11 reads a sentence “an LED lighting device 100 includes three LED arrays 110, 120, and 130, each having two terminals” from the “Detailed Description” part, and can identify the numerical component labels “100,” “110,” “120,” and “130” from the sentence, the word “an” is determined as an article, and the word “includes” is determined as a predicate, so the phrase “LED lighting device” between the word “and” and the component label “100” is determined as the component name of the component label “100.” Accordingly, the word “three” is determined as a quantifier, so the phrase “LED arrays” between the word “three” and the component labels “110,” “120,” and “130” is determined to be the component name of the component labels “110,” “120,” and “130.” Furthermore, the identification module 11 identifies the figure labels (such as “FIG. 1”) of the figures from the brief descriptions.

In step S50, the association module 12 creates associations between the one or more figures in the drawing part and the brief descriptions in the text part according to the figure labels. As mentioned above, the figure labels are respectively identified from the drawing part and the brief descriptions in the text part. For example, the brief descriptions in the text part may include a brief description as follows: “FIG. 1 is a circuit diagram showing an LED lighting device according to a preferred embodiment of the present invention,” and the figure label “FIG. 1” is identified from the brief descriptions as well as from the drawing part which includes a drawing of “FIG. 1.” As such, an association can be made between the drawing of “FIG. 1” and the brief description of “FIG. 1” according to the figure label “FIG. 1”.

In step S60, the displaying module 13 displays miniatures of the figures in the first area 50 of the user interface module 14, and displays a figure corresponding to a selected miniature in the second area 60 of the user interface module 14 (as shown in FIG. 5 and FIG. 6). In one embodiment, the miniatures of the figures in the first area 50 and the figure in the second area 60 can be displayed in the preset direction.

In step S70, the displaying module 13 displays the brief descriptions of the figures in the fourth area 80 of the user interface module 14 (as shown in FIG. 5 and FIG. 6).

In step S80, the displaying module 13 displays control buttons in the third area 70 of the user interface module 14 to control display of the figure displayed in the second area 60. For example, the control buttons may include a page-up button 71, an input box 72, a page-down button 73, and a rotation button 74 as shown in FIG. 5 and FIG. 6. A user may use the page-up button 71 and the page-down button 73 to change the figure displayed in the second area 50. For example, when “FIG. 1” is presently displayed, the user may click the page-down button 73 once to display “FIG. 2”. In another way, the user may input a figure label (such as “FIG. 1”) or a number corresponding to the figure label (such as “1” shown in FIG. 5) to display a desired figure in the second area 60. By operating the rotation button 74, the user may rotate the figure displayed in the second area. In other embodiments, more buttons, such as zoom in/zoom out buttons, may be displayed in the third area 70.

In step S90, the displaying module 13 displays a brief description associated with the figure displayed in the second area 60 in a preset manner. In one embodiment, the preset manner may be to highlight the brief description associated with the figure displayed in the second area 60 (such as coloring or bolding the characters as shown in FIG. 5), or remove the brief description associated with the figure to be displayed in a position facilitating the user to view the brief description associated with the figure. As shown in FIG. 5, “FIG. 1” is presently displayed in the second area 60, a brief description “FIG. 3 is a circuit diagram showing an LED lighting device according to still another preferred embodiment of the present invention” is displayed in its original position at the bottom of the fourth area 70. When the second area 60 is controlled to display “FIG. 3,” the brief description “FIG. 3 is a circuit diagram showing an LED lighting device according to still another preferred embodiment of the present invention” may be relocated to be above the brief description “FIG. 1 is a circuit diagram showing an LED lighting device according to a preferred embodiment of the present invention.”

In step S100, when a pointing device is detected as pointing to a coordinate range of a component label in the figure displayed in the second area 60, the displaying module 13 displays a component name corresponding to the component label in the second area 60. As shown in FIG. 6, when a pointing device, e.g. a cursor, points to the coordinate range of the component label “110,” the corresponding component name “LED arrays” is displayed adjacent to the component label “110.”

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A file reader applied in a computing device comprising one or more programs, which comprise instructions that are stored in a non-transitory computer-readable medium, when executed by a processor of the computing device, the file reader performs operations of:
(a) identifying a text part and a drawing part of a file read from a storage device; and
(b) displaying the text part and the drawing part in different areas of a user interface.

2. The file reader as claimed in claim 1, wherein operation (a) comprises:
identifying figure labels of one or more figures in the drawing part and component labels in each figure, and determining a coordinate range of each component label in the figure.

3. The file reader as claimed in claim 2, wherein operation (a) further comprises:
identifying brief descriptions of the one or more figures, the component labels, component names from the text part, and the figure labels of the one or more figures from the brief descriptions.

4. The file reader as claimed in claim 2, wherein operation (b) comprises:
displaying miniatures of the one or more figures in a first area of the user interface; and
displaying a figure corresponding to a selected miniature in a second area of the user interface.

5. The file reader as claimed in claim 3, wherein operation (a) further comprises:
creating associations between the one or more figures in the drawing part and the brief descriptions in the text part according to the figure labels.

6. The file reader as claimed in claim 5, wherein operation (b) further comprises:
in response to detecting that a pointing device is pointing to a coordinate range of a component label in the figure displayed in the second area, displaying a component name corresponding to the component label in the second area.

7. The file reader as claimed in claim 5, wherein operation (b) further comprises:
displaying control buttons in a third area of the user interface to control display of the figure displayed in the second area; and
displaying the brief descriptions of the one or more figures in a fourth area of the user interface.

8. The file reader as claimed in claim 7, wherein operation (b) further comprises:
displaying a brief description associated with the figure displayed in the second area in a preset manner.

9. The file reader as claimed in claim 8, wherein the preset manner is highlighting the brief description associated with the figure displayed in the second area.

10. The file reader as claimed in claim 8, wherein the preset manner is removing the brief description associated with the figure to be displayed in a position of the user interface, at which the brief description associated with the figure is to be viewed by a user.

11. A method being executed by a processor of a computing device, comprising steps:
(a) identifying a text part and a drawing part of a file read from a storage device by the processor; and
(b) displaying the text part and the drawing part in different areas of a user interface by the processor.

12. The method as claimed in claim 11, wherein step (a) comprises:
identifying figure labels of one or more figures in the drawing part and component labels in each figure, and determining a coordinate range of each component label in the figure;
identifying brief descriptions of the one or more figures, the component labels, component names from the text part, and the figure labels of the one or more figures from the brief descriptions; and
creating associations between the one or more figures in the drawing part and the brief descriptions in the text part according to the figure labels.

13. The method as claimed in claim 12, wherein step (b) comprises:
displaying miniatures of the one or more figures in a first area of the user interface;
displaying a figure corresponding to a selected miniature in a second area of the user interface;
displaying control buttons in a third area of the user interface to control display of the figure displayed in the second area; and
displaying the brief descriptions of the one or more figures in a fourth area of the user interface.

14. The method as claimed in claim 13, wherein step (b) further comprises:
in response to detecting that a pointing device is pointing to a coordinate range of a component label in the figure displayed in the second area, displaying a component name corresponding to the component label in the second area.

15. The method as claimed in claim 13, wherein step (b) further comprises:
displaying a brief description associated with the figure displayed in the second area in a preset manner.

16. A non-transitory computer-readable medium having stored thereon instructions that, when executed by a processor of a computing device, cause the processor to perform operations of:
(a) identifying a text part and a drawing part of a file read from a storage device by the processor; and
(b) displaying the text part and the drawing part in different areas of a user interface by the processor.

17. The non-transitory computer-readable medium as claimed in claim 16, wherein operation (a) comprises:
identifying figure labels of one or more figures in the drawing part and component labels in each figure, and determining a coordinate range of each component label in the figure;
identifying brief descriptions of the one or more figures, the component labels, component names from the text part, and the figure labels of the one or more figures from the brief descriptions; and
creating associations between the one or more figures in the drawing part and the brief descriptions in the text part according to the figure labels.

18. The non-transitory computer-readable medium as claimed in claim 17, wherein operation (b) comprises:
displaying miniatures of the one or more figures in a first area of the user interface;
displaying a figure corresponding to a selected miniature in a second area of the user interface;
displaying control buttons in a third area of the user interface to control display of the figure displayed in the second area; and
displaying the brief descriptions of the one or more figures in a fourth area of the user interface.

19. The non-transitory computer-readable medium as claimed in claim 18, wherein operation (b) further comprises:
in response to detecting that a pointing device is pointing to a coordinate range of a component label in the figure displayed in the second area, displaying a component name corresponding to the component label in the second area.

20. The non-transitory computer-readable medium as claimed in claim 18, wherein operation (b) further comprises:
displaying a brief description associated with the figure displayed in the second area in a preset manner.
